(19) United States
(12) Patent Application Publication
(10) Pub. No.: US 2008/0064404 A1
(43) Pub. Date: Mar. 13, 2008

(54) METHODS AND DEVICE FOR USER TERMINAL BASED FAST HANDOFF

(75) Inventors: Yanfeng Zhang, Beijing (CN); Yongqiang Liu, Beijing (CN); Yong Xia, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (China) Co., Ltd., Beijing (CN)

(21) Appl. No.: 11/850,209

(22) Filed: Sep. 5, 2007

(30) Foreign Application Priority Data
Sep. 7, 2006 (CN) 200610126191.1

(51) Int. Cl. H04Q 7/20

(52) U.S. Cl. 455/436

(57) ABSTRACT

Methods and device for user terminal based fast handoff are provided. User terminal builds a neighbor group list in which possible neighbor access points (APs) are divided into one or more groups. When a handoff needs to be prepared, the user terminal performs intermittently multiple pre-break probing subphases according to the neighbor group list while not breaking connection with a current serving AP. In each PBP subphase, signal qualities of neighbor APs in one group are probed in a manner of active probing. The user terminal selectively performs handoff according to the probed signal qualities of the neighbor APs. The user terminal may build the neighbor group list based on information of neighbor APs derived through overlapped channel scanning or information of neighbor APs received from the serving AP. The neighbor APs belonging to the same group work on the same channel and in each PBP subphase, a group of neighbor APs may be probed by using unicast probe request.

### FIELD OF THE INVENTION

The invention relates generally to wireless communication, and more particularly to a method and device for performing fast link-layer handoff to minimize the communication disruption period which occurs when a user terminal (STA) moves away from its current associated access point (AP) to another nearby AP.

### BACKGROUND

IEEE 802.11 standard defines two operating modes: an ad hoc mode and an infrastructure mode. In the ad hoc mode, two or more STAs can recognize each other and establish a peer-to-peer communication without the need of an AP. In the infrastructure mode, there is at least one AP. The AP and one or multiple STAs it supports are known as a Basic Service Set (BSS), which roughly corresponds to a cell in cellular network environment. A STA uses the AP to access the resources of a wired network, as well as to communicate with other STAs within the same BSS. The wired network can be an organization intranet or the Internet, depending on the placement of the AP. A set of two or more BSSs connected by a distributed system (DS) form an Extended Service Set (ESS), identified by its Service Set Identifier (SSID). If the radio coverage areas of two APs overlap, handoff occurs when a STA moves out of the coverage area of an AP and enters that of another AP.

The handoff procedure involves a sequence of actions and messages exchanged by the STA and neighbor APs, resulting in the transfer of STA's connection from the serving AP to a new AP. During this period, the communication link between the STA and the serving AP is broken, and the STA is not able to send or receive any data packet until establishing a new link with the new AP. So, there is a communication disruption period as illustrated in FIG. 1, which starts from the time the existing communication link is broken to the time when the new link is established. The STA initiates the handoff procedure when it detects that the link quality with the serving AP has degraded below a specific threshold.

As shown in FIG. 1, the communication disruption period is comprised of a scanning process (also called discovery process) and an authentication and re-association process. During the scanning process, the STA needs to switch to each radio frequency (channel) to discover whether there is any AP working on this channel. This scanning process can take up to several hundred milliseconds and occupy over 90% of the whole handoff latency. The authentication and re-association process takes only a few milliseconds to complete.

The channel scanning process can be accomplished in passive or active mode. With passive scanning, STA switches to each candidate channel and listens to periodic beacon frames from APs. An AP uses beacon to announce its presence, its working channel, its BSSID and other parameters for STA's access. The AP broadcasts its beacons periodically (typically every 100 ms). So, to get information about all the APs in a certain channel, the STA has to stay in the channel for at least a beacon period. Comparatively, with active scanning, STA broadcasts Probe Requests in each candidate channel and waits for Probe Responses from neighbor APs working on that channel. An AP sends unicast Probe Response to the STA after receiving the Probe Request. The Probe Response frame carries the same parameters as in the beacon frame. In both cases, after scanning all candidate channels, STA selects the best AP from the records to perform the second process—authentication and re-association.

Due to limited coverage of a BSS, the time for a mobile user to stay in a cell may be on the order of only several minutes, or even a few seconds, depending on its moving speed. Real-time interactive applications have strict quality requirement. For example, VoIP requires its end-to-end delay to be lower than 250 ms, delay variance or jitter lower than 50 ms, and packet loss rate less than 1%. However, with the standard 802.11 protocol, the handoff process can not meet the requirements of real-time interactive applications for the following two reasons:

(1) the communication disruption period is too long (about 500 ms); and
(2) the long communication disruption causes packet loss.

Offering real time handoff is an essential requirement for VoIP and other real time services like video conference. How to provide fast link-layer handoff in WLAN environment is an active research subject, and there are already some related inventions to reduce the handoff latency. Since the scanning process dominates the communication disruption period of a handoff, almost all these inventions attempt to shorten this process. According to the said two modes of scanning process, these inventions fall into two categories: 1) active scanning and 2) passive scanning.

Active scanning is further categorized as full-scanning and selective-scanning according to the number of scanned channels. Full-scanning is a scheme that probes all the legitimate channels (for example, all eleven channels for 802.11b). Selective-scanning, on the other hand, limits scanning to a subset of legitimate channels. The latency of active scanning is affected significantly by two parameters: the probe count and the probe wait time. Most of inventions using active scanning intent to decrease the probe count. An example is Reference 1 (PCT international publication WO2004/054283A2 by Zhong et al., entitled “System and Method for Performing a Fast Handoff in a Wireless Local Area Network”), which discloses a system and method using a table of pre-configured nearest-neighbor APs to perform a prioritized scanning in the communication disruption period. In Reference 2 (S. Shin, A. Forte, et al., “Improving the Latency of 802.11 Handoff Latency in IEEE 802.11 Wireless LANs,” in Proceedings of the Second International Workshop on Mobility Management and Wireless Access Protocols, Philadelphia, USA, 2004), selective scanning and “AP cache” which records the scan results of last scanning are used to realize a link-layer fast handoff. The probe count and the probe wait time are reduced in Reference 3 (M. Shin, A. Mishra, and W. Arbaugh, “Improving the Latency of 802.11 Handoffs using Neighbor Graphs,” in Proceedings of the ACM MobiSys Conference, Boston, Mass., USA, June 2004) by using neighbor graphs and non-overlap graphs. The neighbor graphs construction and probing method is also presented in Reference 4 (US2006/0092883A1). Reference 5 (US2006/0072507A1, entitled “Minimizing Handoffs and Handoff Times in Wireless Local Area Networks”) presents a method, in which the number of channels that are scanned during a handoff is reduced by tracking past user movements within the WLAN.

Some inventions strive to improve the performance of passive scanning. SyncScan in Reference 6 (Ishwar Ramani, and Stefan Savage, “SyncScan: Practical Fast Handoff for 802.11 Infrastructure Networks,” in Proceedings of the IEEE Infocom Conference 2005, Miami, Fla., March 2005) synchronizes the short listening periods at the STA with regular periodic beacon transmission from all the APs. With the knowledge of when the APs on a certain channel will broadcast their beacons, STA can switch to the channel at a particular time and get all broadcasting beacons from these synchronized APs without waiting for a full beacon period. Since it takes very short time to scan a channel, the STA can perform the scanning process before breaking its current connection with its serving AP. The handoff latency is consequently shorted greatly. In Reference 7 (US2005/0047371A1 by Richard L. Bennett, entitled “Passive Probing for Handoff in a Local Area Network”), the serving AP has responsibility to send probe requests to its neighbor APs and inform them of a defined time and a response interval at which they transmit their probe responses. STA is also informed by its serving AP of the defined time, the response interval and the defined channel at which it can hear the probe response from one of its neighbor APs. With the probe responses, the STA can make decision about when to handoff and which neighbor AP to handoff to. In Reference 8 (Vivek Mhatre, and Konstantina Papagianuaki, “Using Smart Triggers for Improved User Performance in 802.11 Wireless Networks,” in Processing of the ACM MobiSys Conference, Uppsala, Sweden, June 2006), a mechanism is adopted by which STA can hear the beacon from its neighbor APs on the same or overlapping channels with its current channel. Then with a complementary algorithm, the STA can make the right decision which neighbor AP can provide better link quality.

In all the active scanning methods above, the scanning process keeps in the communication disruption period, that is to say, these methods still conform to the pattern illustrated in FIG. 1, and although being shorten, the channel scanning process still contributes the dominating latency for the disruption period. Moreover, with these methods, STA can not monitor the signal quality of nearby APs continuously, so it can initiate scanning only when the signal with the serving AP has degraded below a threshold, with which connection has to interrupt or endures poor and unsustainable performance, even if there exists a nearby AP with better link quality. Therefore, the STA cannot always choose the best AP to make association with. After scanning, the STA chooses the best AP only according to the one-time sampling result, so the temporary fluctuation of signal can put some influence on the correctness of the AP selection. All these methods require modifying both AP and terminal.

In order to reduce the co-channel interference, people try to use non-overlapped channels to cover a certain area, such as channel 1, 6 and 11 for 802.11b. It is very different with the assumption presented in Reference 8, which assumes there always exist multiple neighbor APs operating in the overlapped channel with the serving AP. Therefore, if there is no neighbor AP operating in the overlapped channel, it is impossible for the STA to find an available AP to connect with. For example, if STA communicates with its serving AP in channel 1 and neighbor APs operate in channel 6 and 11, the STA will use the standard 802.11 handoff procedure. On the other hand, even if there exist some neighbor APs in overlapped channel, the STA often can't find the best AP (which might work on some other non-overlapped channel) to connect with, since it can only get the information about its neighbor APs on the same or overlapped channel.

SyncScan and Reference 7 can enable STA to monitor the quality of nearby APs continuously, so the time-consuming scanning process is eliminated from the communication disruption period. But, both of them require precise synchronization mechanism to enable neighbor APs to send out beacons or probe responses at the special time. In order to receive the highly synchronized beacons, terminals also need to be synchronized. Therefore, to implement the two methods, modification is needed for both AP and user terminals. In large-scale wireless network, there is some difficulty to make all APs and STAs synchronized with high precise.

### SUMMARY OF THE INVENTION

The present invention is made in view of the above problems.

The present invention uses active probing to perform scanning process. The time-consuming scanning process is also eliminated from the communication disruption period as SyncScan. In the present invention, all scanning and handoff actions are performed by STA itself and no modification is needed on APs and the network behind APs.

In the present invention, the time-consuming scanning process, taking place in the communication disruption period, is divided into multiple probing subphases based on neighbor information, and these probing subphases are performed before STA has to break the communication with the serving AP. Each probing subphases takes only a little fraction of time, and between two probing subphases, there is still an interval available for data traffic. That is, these probing subphases are performed while the STA still keeps its communication with its serving AP. With these probing results from the subphases, the STA can make a decision about whether a handoff is needed, when to handoff and which neighbor AP is the best candidate to associate with, even before breaking the communication with its serving AP. When the STA decides to handoff, the actual handoff process only includes the “authentication and re-association” process and can be performed in just a few milliseconds.

The following summarizes the steps required for the completion of client-based fast handoff according one embodiment of the invention:
(1) After associating or re-associating with an serving AP, STA builds a neighbor group list of the current serving AP, in which neighbor APs of the current serving AP are grouped. APs in one group work on the same channel, and the number of APs in one group may be limited by a maximum group size. An AP may derive information of neighbor APs or build a neighbor group list by using history data of STAs' past movement and handoff, and then a STA may get information of neighbor APs from the serving AP. STA may also get information of neighbor APs with overlapped channel scanning method, and thus no modification is needed for APs and the network behind APs.
(2) The STA periodically measures the link quality (Received Signal Strength Indicator, RSSI) of the serving AP to decide when to perform pre-break probing (PBP) operation.

After the RSSI of the serving AP drops below a special signal quality value, the STA enters the PBP status.
(3) In PBP status, the channel scanning is accomplished with multiple PBP subphases, and in each PBP subphase, only a group of neighbor APs are probed according to the result of said grouping.
(4) Before performing each PBP subphase, the STA informs its serving AP to buffer inbound traffic to the STA with power save mode, and the STA also begins to buffer outbound traffic by itself, so no packet loss takes place during PBP subphases.
(5) The probe frequency for a special AP is adaptively adjusted to decrease load of CPU and power consuming, according to the signal quality of that AP.
(6) The STA sends and receives data traffic with the serving AP during the interval between two adjacent PBP subphases.
(7) After getting enough probing results, the STA calculates moving average of RSSI for all neighbor APs and chooses the best AP. By comparing the RSSI of the best AP with the RSSI of the serving AP, the STA decides whether a handoff is needed.
(8) If a handoff needs to be performed, the STA breaks the connection with the serving AP, switches its channel and makes authentication and re-association with the best AP selected.

The method of the present invention reduces handoff delay by over an order of magnitude in comparison with the existing approach. The actual handoff can occur in a few milliseconds rather than hundreds of milliseconds latency incurred by using standard 802.11 implementations.

During probing subphase, the AP in PSM mode buffers the inbound traffic for the STA and the STA buffers the outbound traffic by itself, so no packet loss is caused in probing subphase.

A continuous scanning implementation can discover the presence of access points with stronger Signal Noise Ratio (SNR), even before the associated access point's signal has degraded below a threshold such that the connection has to be broken. Thereby the handoff method improves the connection performance of the client in the presence of APs of better performance.

The whole method of the invention can be implemented in client terminals, and no synchronization and other modifications are required for access points and the network behind APs.

### BRIEF DESCRIPTION OF THE DRAWINGS

The above and other objects, features and advantages of the present invention will be better understood from the following description, taken in conjunction with the accompanying drawings in which like reference numerals refer to like parts and in which:

FIG. 1 is a diagram illustrating the communication disruption caused by traditional 802.11 handoff;

FIG. 2 is a diagram schematically illustrating the overlapped coverage of two APs;

FIG. 3 is a block diagram schematically illustrating the configuration of a user terminal according to one embodiment of the invention;

FIG. 4 is diagram illustrating an example of the neighbor group list;

FIG. 5 is a flow chart illustrating the operation of the user terminal according to one embodiment of the invention;

FIG. 6 is a sequence chart schematically illustrating a PBP process according to the invention;

FIG. 7 is a sequence chart schematically illustrating the channel occupied time during a PBP process according to the invention;

FIG. 8 is a block diagram schematically illustrating the configuration of a user terminal according to another embodiment of the invention; and

FIG. 9 is a sequence chart schematically illustrating the operation for a PBP subphase according to one embodiment of the invention.

### DETAILED DESCRIPTION OF THE PREFERRED EMBODIMENTS

The present invention provides methods, devices and systems for performing fast handoff of wireless service between access points of a wireless network.

In overview, the present invention relates to wireless communications devices or units and wireless communication systems. The former is often referred to as client stations (STAs), such as laptop, PDA, smart phone equipped with WLAN interface, and so on. The latter is often referred to as access points (APs) and the network behind them, which provides services such as video, voice and data communications to STAs. More particularly, various inventive concepts of the invention are embodied in STAs and access points as well as methods therein for providing a handoff of video, voice and data communications services between access points of a wireless network through neighbor group list assisted pre-break probing. Neighbor group list assisted pre-break probing is defined as such means by which the STA can use the information of neighbor group list to divide the time-consuming scanning process into multiple probing subphases, and probe a group of neighbor APs in a manner of active probing in each subphase while keeping the on-going communication.

The communication system and STAs of particular interest are those that may provide or facilitate short range communications capability normally referred to as WLAN capabilities, such as IEEE 802.11, Bluetooth, or HiperLAN and the like that preferably utilize orthogonal frequency division multiplex (OFDM), code division multiple access (CDMA), frequency hopping access technologies.

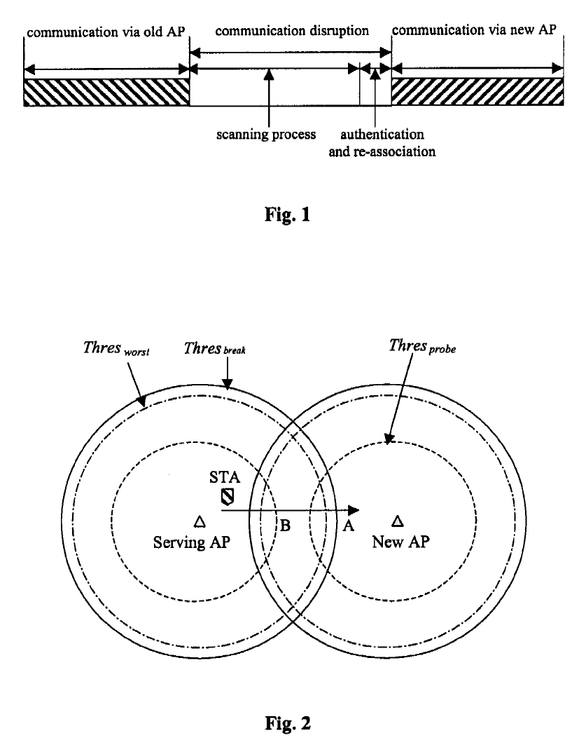

In such a system, for providing high user capacity within a limited spectrum, a plurality of access points are needed so as to form many low powered cells, each covering only a small portion of the service area. Due to the limited coverage of each cell, STA often moves into a different cell while a session is in progress, so a handoff process is needed to identify the next AP and transfer the on-going session. To enable STA handoff from the coverage of a serving AP to the coverage of another AP, the coverage of the two APs must be overlapped as shown in FIG. 2. It means that there must be a common area between the coverage of the two APs, in which STAs can selectively build connection and communicate with either of the two APs. In the present invention, if two APs are overlapped, one of them is called as a neighbor of the other, and vice versa.

The fundamental problem behind today's handoff mechanisms can be attributed to the fact that STA triggers a handoff event upon loss of connectivity or poor and unsustainable performance, and scanning takes most of the time of the communication disruption period.

When a STA is about to handoff, it has already been experiencing poor performance before breaking the current connection, and after breaking the current connection, it needs to scans all possible channels to collect information about neighbor APs. As illustrated in FIG. 2, when a STA moves away from the serving AP, the RSSI of the serving AP drops gradually.

When the RSSI of the serving AP turns lower than the threshold Thres_{break} (the lowest RSSI value with which STA can maintain communication), the STA triggers handoff, breaks the on-going connection and begins to scan neighbor APs. Thres_{break} also indicates the border of the AP's coverage.

In the method of the invention, it is suggested that STAs should not wait until they lose connectivity or experience poor performance to seek alternative APs. In other words, STAs should be proactive, and not reactive to poor performance. The channel scanning, the scanning result evaluation and the best candidate AP selection should be accomplished before breaking the current connection. Therefore, if there exists a neighbor AP, which can provide better link quality than the serving AP, STA can always discover and connect with it before the STA's current link quality drops into a very poor status. Thus when the STA decides to perform handoff, the handoff only consists of breaking the current connection, switching the channel, making authentication and re-association with the new AP, so the handoff can be minimized.

To achieve the above object, the invention provides a new handoff method named neighbor group list assisted pre-break probing handoff as well as a related terminal. The method replaces the time-consuming channel scanning phase with multiple pre-break probing (PBP) subphases, and performs these PBP subphases without breaking the current connection.

The impact on current data traffic caused by each PBP subphase is minimized by neighbor group list assisting, unicast probing, buffering in STA and serving AP.

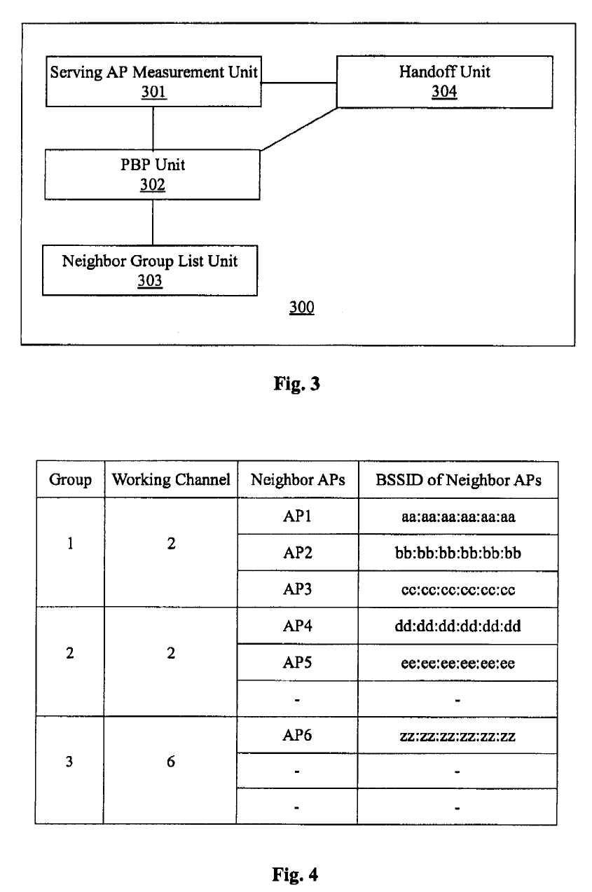

FIG. 3 shows the configuration of a user terminal according to one embodiment of the invention. STA 300 mainly comprises a serving AP measurement unit 301, a pre-break probing unit 302, a neighbor group list unit 303 and a handoff unit 304.

The serving AP measurement unit 301 is used for measuring the signal quality of the current serving AP for the STA 300. The neighbor group list unit 303 is used for building a neighbor group list. In the neighbor group list, possible neighbor APs are grouped into one or more groups. The neighbor APs belonging to the same group work on the same channel. The neighbor group list unit 303 may set a maximum group size Max_group according to the particular situation such that the number of the neighbor APs of each group in the neighbor group list is not greater than that predetermined value.

FIG. 4 shows an example of the neighbor group list used by the user terminal according to one embodiment of the invention. In this example, the maximum group size Max_group is set to 3. In this example, six neighbor APs (AP1-AP6) are grouped into three groups. The first group is comprised of AP1-AP3 that operates on channel 2, the second group is comprised of AP4 and AP5 that operates on channel 2, and the third group is comprised of AP6 that operates on channel 6. In addition, the neighbor group list also comprises the BSSID of each neighbor AP. It should be noted that the structure of the neighbor group list is not limited to the example illustrated in FIG. 4. For example, the neighbor group list may also comprise the other information of the neighbor APs, such as SSID and the like.

STA may build the neighbor group list by use of information of neighbor APs derived through various ways. For example, STA may perform overlapped channel scanning to derive information of neighbor APs. In this case, the neighbor group list unit 303 may comprise means for performing overlapped channel scanning to derive information of neighbor APs (not shown). APs may record STAs' past movement and handoff history, and derive information of neighbor APs or build the neighbor group list from such history data, and then STA may receive information of neighbor APs from a serving AP. In this case, the neighbor group list unit may comprise means for receiving information of neighbor APs from the serving AP (not shown). In one embodiment, information of neighbor APs received from the serving AP may be a list including at least the working channel and BSSID of each neighbor AP.

Referring back to FIG. 3, when a handoff is to be prepared, the pre-break probing unit 302 of STA performs intermittently multiple PBP subphase according to the neighbor group list while not breaking the connection with the current serving AP. In each PBP subphase, the pre-break probing unit 302 probes signal qualities of neighbor APs in one group in a manner of active probing. Based on the information from the neighbor group list, the pre-break probing unit 302 may scan the corresponding neighbor APs in each PBP subphase by unicast probe request instead of multicast probe request.

Then, based on the signal qualities of the serving AP and neighbor APs obtained by the serving AP measurement unit and the pre-break probing unit, the handoff unit 304 selectively performs handoff.

It should be appreciated that, although not shown, STA may comprise any other known components, e.g., display means such as liquid crystal display for displaying information, user input means such as keypad, buttons, microphone and the like, interface meaning such as WLAN card and so on, the detailed descriptions of which are omitted herein.

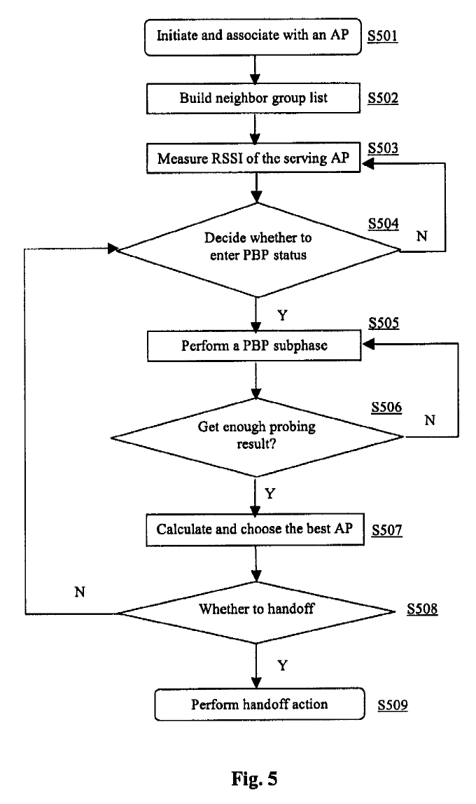

FIG. 5 shows a flow chart of the operation of a STA according to one embodiment of the invention.

First, the STA initiates a connection and associates with an AP (step S501). After associating or re-associating with the AP, the STA gets information of the possible neighbor APs of the current serving AP, and groups, according to the channels and a predetermined maximum group size, the possible neighbor APs to build a neighbor group list (step S502). Then, the STA periodically measures the signal quality (RSSI) of the serving AP (step S503) to decide when to perform PBP operation (step S504). After the RSSI of the serving AP drops below than the Thres_{probe} (as shown in FIG. 2), the STA enters PBP status (step S505). In PBP status, the channel scanning is accomplished with multiple PBP subphases. In each PBP subphase, only a group of neighbor APs is probed according the neighbor group list. Meanwhile, the STA sends and receives the data traffic with the serving AP during the interval between two adjacent PBP subphases, and records the RSSI of the serving AP. After getting enough probing results (step S506), the STA calculates moving average of RSSI for all neighbor APs and chooses the best one (step S507). By comparing the RSSI of the best AP with the RSSI of the serving AP, the STA decides whether a handoff is needed (step S508). If a handoff is needed, the STA breaks the connection with the serving AP, switches its channel and makes authentication and re-association with the best AP selected (step S509).

After the STA associates or re-associates with an AP, it continuously samples the RSSI of the serving AP, and calculates its moving average value (RSSI_{curr}). The STA may always search for the best neighbor AP by using PBP. However, it is preferable that only when it is necessary to prepare for handoff, that is, RSSI_{curr} falls below Thres_{probe}, STA begins to perform the PBP operation. Thres_{probe} indicated by the dash line in FIG. 2, as a new RSSI threshold, must be some higher than Thres_{break}, so that STA can keep the communication capability with the serving AP while performing the PBP phase. If Thres_{probe} is too high, PBP will be performed even when the STA's connection quality with the serving AP keeps good enough, resulting in some bad impact on the data traffic. Therefore, it is preferable that a critical RSSI value, which causes a change of the data rate of STA (e.g., from 5.5 Mbps to 2 Mbps), is selected as Thres_{probe}.

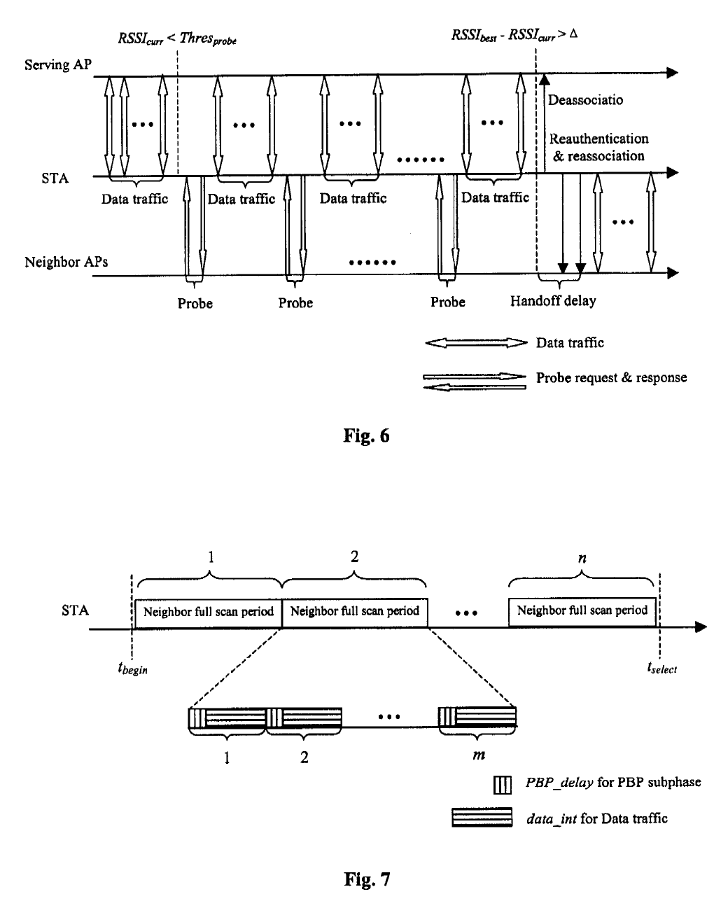

In PBP status, because the STA has no knowledge of the exact beacon time of neighbor APs, it still uses active discovery process—probing to scan APs. FIG. 6 schematically illustrates a sequence chart of the PBP process. As shown in FIG. 6, the STA periodically takes short intervals to do probing, and most of time is still left for data traffic. When the STA has probed all neighbor APs for enough times, it begins to calculate the moving average of RSSI for every neighbor AP. By comparing the average RSSIs of the neighbor APs, the best neighbor AP can be selected, whose average RSSI is RSSI_{best}. From the beginning of the PBP status, the STA has always been sampling the RSSI of the serving AP, so the moving average of RSSI from the serving AP also can be calculated. With the result of sampling and averaging, if the RSSIs of the neighbor APs and the serving AP meets the conditions as follows (Δ is the margin, used to avoid unnecessary handoff operations that might produce a “ping-pong” effect when the STA are equally well served by different access points):

RSSI_{best}−RSSI_{curr}>Δ (1)

the STA chooses the best neighbor AP as the candidate AP to connect. Based on the select candidate AP, STA breaks the connection with serving AP and makes the authentication and re-association with the best neighbor AP, so the total latency of handoff process just consists of three parts: channel switch and transmission (CS&T), authentication (tₐᵤₜₕ) and re-association (t_{assoc}).

t_{handoff}=CS&T+tₐᵤₜₕ+t_{assoc} (2)

CS&T is an inherent value (about 5-7 ms) for a WLAN card. Authentication is required to validate the STA's right to use a particular access point, and with opening system, the authentication (tₐᵤₜₕ) takes about 3-5 ms to finish. t_{assoc} is the time used by the STA to rebuild association relationship with a new AP, and costs about 3-5 ms. Therefore with PBP algorithm, the total handoff latency can be cut down to less than 20 ms.

In each PBP subphase, the STA must pause its current communication with the serving AP, switch channels, performing probing task and then switch back. The time used for a PBP subphase (PBP_delay) is:

PBP_delay=2*CS&T+Probe_time (3)

where Probe_time is the time STA use to send probe requests and wait the probe responses.

To reduce the short term fading effects of signal, multiple periodic probing must be formed for the same AP, and then by calculating the average value of RSSI samples, the best AP can be chosen. If the moving average of n RSSI samples for an AP can provide a reliable and stable estimate of the AP's signal quality, and STA needs m PBP subphases to complete a fully probing for all neighbor APs, the STA should complete at least n*m PBP subphases before calculating and selecting the best AP to connect. FIG. 7 is a sequence chart schematically illustrating the channel occupied time during a PBP process. As illustrated in FIG. 7, STA enters PBP status at the timing t_{begin}. From t_{begin} to t_{select}, the STA accomplishes n neighbor full scan periods, during each of which the STA probes all neighbor APs for one time by m PBP subphases. At t_{select}, the mobile host, with enough sampling results, begins to calculate and choose the best AP. Thus from t_{begin} to t_{select}, the total time taken by PBP for channel scanning is

PBP_time=n*m *PBP_delay (4)

The interval for data traffic between two consecutive PBP subphases is data_int, and the total time used for data traffic from t_{begin} to t_{select} is

traffice_time=n*m*data_int=(t_{begin}−t_{select})−PBP_time (5)

As can be seen from FIGS. 6 and 7, too many PBP subphases and too long PBP subphases both lead to poor performance for data traffic, and the possible impacts include:

(1) reducing data throughput when STA is in PBP mode;
(2) adding delay jitter to data traffic arriving in PBP subphases;
(3) causing packet loss for UDP traffic arriving in PBP subphases; and
(4) increasing CPU load due to too many PBP subphases.

In view of this, the method of the invention employs a neighbor group list to reduce the number of neighbor APs to be probed, so m can be reduced. In addition, with the neighbor group list, unicast probe request may be used to shorten PBP_delay.

The simplest method to divide channel scanning phase into multiple PBP subphases is to scan one or several channels in each subphase. In each subphase, STA switches itself into a probing channel, sends broadcasting probe requests, waits probe responses for a special interval, and then switches back. However, this method presents such disadvantages:

(1) scanning all neighbor APs needs too many PBP subphases, for example 11 subphases for 802.11b/g and over 20 subphases for 802.11a;
(2) even in the case that there is no neighbor AP in a certain channel, STA still needs to employ a PBP subphase to scan the channel; and
(3) with broadcasting probe request, STA has to wait in the channel for maximum channel time (MaxChannelTime), even if there is only one neighbor AP in this channel.

In the method of the invention, a neighbor group list of serving AP is employed to reduce the number of necessary PBP subphases and the waiting time of each PBP subphase. The neighbor group list of an AP keeps the records of its neighbor APs, and each record includes at least a first field identifying a neighbor AP (usually MAC address or BSSID of the AP) and a second field identifying the neighbor AP's operation channel. Information of the neighbor APs can be built by the serving AP, the backbone infrastructure behind the serving AP (such as an Ethernet switch, a special server and so on) or even the STA itself. The methods to built neighbor group list include manual pre-configuration, recording the STAs' past movement and handoff history, scanning by STA and future protocol standard—802.11k, and so on.

With a neighbor group list, the set of channels on which neighbor APs are operated and the set of neighbor APs on each of such channels can be obtained by STA before PBP phases. According to Reference 8, using information of neighbor APs, the number of neighbors that needs to be probed can be dropped to 3.15 on average with a maximum of 6 while the average neighbor channel count is 2.25. Thereby, STA only needs to probe these channels and APs.

In order to remove the requirement of modification for APs and the network behind APs, a new method—overlapped channel detecting is used for STA to get information of neighbor APs and build neighbor group list by itself. After associating with an AP, the STA performs several neighbor AP detecting subphases. In each of these subphases, the STA chooses to a channel to broadcast a probe request. With the probe request, APs in the same channel and overlapped channels will send back probe response. Although the STA cannot tell the right signal quality of an AP in the overlapped channel, it still can get information of the AP such as the BSSID and the working channel. The information can be used by STA to build the neighbor group list of its serving AP. For example, assuming that the STA broadcasts a probe request in channel 3, it can get information of APs working in channel 1, 2, 3, 4, and 5. Thereby, the STA can get information of the BSSIDs and the working channels of all neighbor APs by using 3 subphases. The interval between two neighbor AP detecting subphases still keeps for data traffic.

After getting the information of neighbor APs, the STA groups the neighbor APs according to the working channels of the neighbor APs so as to build a neighbor group list. In addition, if there are multiple neighbor APs in the same channel, the number of neighbor APs in each group is further limited by a maximum group size—Max_group. The grouping and the maximum group size are used to make assure that every PBP subphases will not cost too much time, and enough time is preserved for data traffic.

With the neighbor group list, STA in PBP status can clearly be informed of the exact identities and channel of APs in each group, so it can use unicast probe request to scan the corresponding neighbor AP, instead of broadcast probe request. With unicast probe request, the probe response from the probed AP will not be deferred by other APs' responses, and STA has not to wait for the maximum channel time MaxChannelTime in each PBP subphase.

It should be noted that during each PBP subphase, although STA can't keep communication with its serving AP, there is still inbound traffic from the serving AP and outbound traffic from upper layer application. If no buffer in the serving AP and the STA, PBP subphase may cause packet loss. Especially, packet loss for outbound traffic during PBP subphase can cause the data rate dropped for the succeeding data interval. To avoid these situations, data buffer means is provided according one embodiment of the invention.

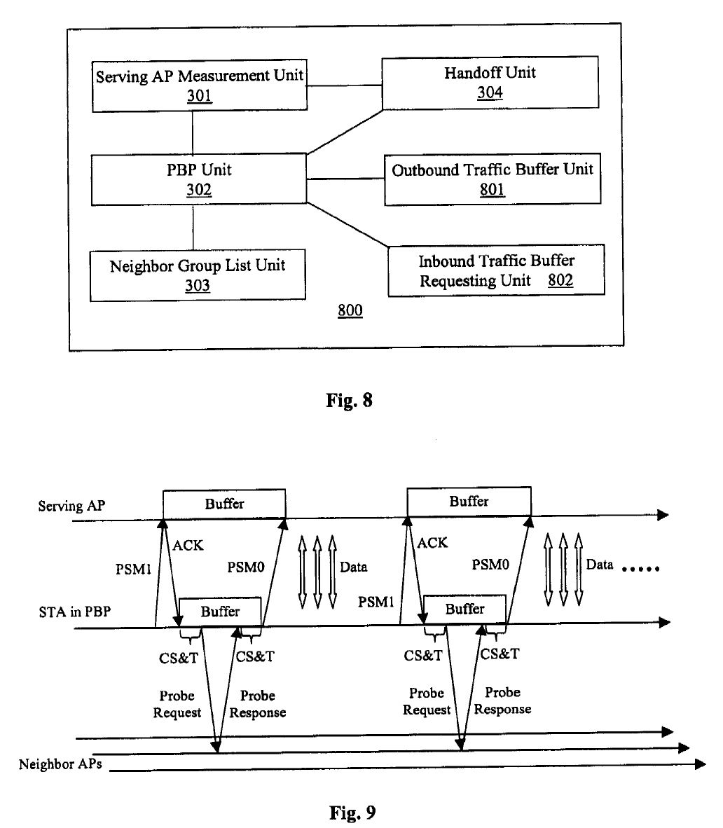

FIG. 8 shows the configuration of a user terminal according to another embodiment of the invention, in which the parts similar to those of FIG. 3 are indicated by the same reference numerals. In the STA 800, an outbound traffic buffer unit 801 and an inbound traffic buffer requesting unit 802 is added. The outbound traffic buffer unit 801 buffers outbound traffic of the STA 800 in each PBP subphase. The inbound traffic buffer requesting unit 802 instructs the serving AP to buffer inbound traffic to the STA 800 in each PBP subphase. With such means, data loss is eliminated. The serving AP can buffer the inbound traffic for the STA in PBP subphase with power save mode (PSM) mechanism. If PBP subphase is short enough, the amount of buffered data in the serving AP is not large, and the buffer can be emptied very quickly after the STA returns to data interval.

With these measures, PBP subphase can be that as shown in FIG. 9. Before switching channel to enter PBP subphases, the STA sends a NULL data frame with PSM bit set to inform the serving AP that it will enter PSM status, then the serving AP returns an ACK packet and begins to buffer inbound traffic for the STA. After receiving the ACK, the STA switches back to the original channel, and then sends another NULL data frame with PSM bit cleared to inform its serving AP that it is ready to receive the buffered traffic. At the same time, the STA begins to transmit the buffered outbound traffic.

With grouping and unicast probe request, the time occupied by a PBP subphase is

PBP_delay=2*CS&T+Max_group*Uni_Probe_time (6)

where Uni_Probe_time is the time between sending unicast probe request and receiving the probe response. In a test, Uni_Probe_time is about 5 ms and Max_group is set to 2, so a PBP subphases takes less than 20 ms. If the period of PBP subphase is set to 100 ms, data traffic will take 80 ms to be transmitted in every 100 ms, which puts less impact on throughput and latency of data packets.

According to this method of the invention, a higher threshold (denoted by Thres_{prob}) is employed to trigger the PBP phase, to ensure that STA has enough time to accomplish the whole PBP phase before breaking the current connection due to the deteriorated signal. However, the higher threshold may lead to more PBP subphases, which will influence the performance of data traffic and increase the load for CPU. To reduce this influence, a new signal threshold Thres_{fast} (Thres_{fast}<Thres_{probe}) and an adaptive algorithm are adopted in one embodiment of the invention to dynamically adjust the probing frequency for a neighbor AP according to its signal quality. In this case, the pre-break probing unit of STA may comprises scan frequency adjusting means.

In particular, STA performs slow probing for a neighbor AP if the neighbor AP's RSSI (RSSIₙₑₜ) and the serving AP's RSSI (RSSI_{curr}) meet the following condition in PBP subphase:

RSSI_{curr}−RSSIₙₑₜ>Thres_{fast} (7)

### Otherwise, the STA performs fast probing for the neighbor AP.

The interval between adjacent PBP subphases of slow probing is longer than that of fast probing, so unnecessary PBP subphases are reduced further.

In summary, according to the invention, the time-consuming channel scanning phase in the standard 802.11 handoff process is replaced with multiple PBP subphases, and these subphases are performed before the current connection is broken. With this method, the handoff latency of the 802.11 protocol can be reduced to less than 20 milliseconds.

In addition, the impact of PBP subphases on data traffic is minimized by adopting neighbor group list assistance, unicast probe request and buffering mechanism (PSM mode in serving AP and buffer in STA). Thereby, the packet loss in PBP subphase is eliminated, and the latency jitter added to data packets in PBP subphases is also minimized to less than 20 ms.

The elements of the invention may be implemented in hardware, software, firmware or a combination thereof and utilized in systems, subsystems, components or sub-components thereof. When implemented in software, the elements of the invention are programs or the code segments used to perform the necessary tasks. The program or code segments can be stored in a machine-readable medium or transmitted by a data signal embodied in a carrier wave over a transmission medium or communication link. The “machine-readable medium” may include any medium that can store or transfer information. Examples of a machine-readable medium include electronic circuit, semiconductor memory device, ROM, flash memory, erasable ROM (EROM), floppy diskette, CD-ROM, optical disk, hard disk, fiber optic medium, radio frequency (RF) link, etc. The code segments may be downloaded via computer networks such as the Internet, Intranet, etc.

Although the invention has been described above with reference to particular embodiments, the invention is not limited by the above particular embodiments and the specific configurations shown in the drawings. For example, some components as shown may be combined with each other as one component, or one component may be divided into several subcomponents, or any other known component may be added. The operation processes are also not limited to those shown in the examples. Those skilled in the art will appreciate that the invention may be implemented in other particular forms without departing from the spirit and substantive features of the invention. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A method for handoff of a user terminal in a wireless communication network, comprising:
measuring signal quality of a current serving access point (AP);
building a neighbor group list in which possible neighbor APs are divided into one or more groups;
performing intermittently multiple pre-break probing (PBP) subphases according to the neighbor group list while not breaking connection with the serving AP, wherein in each PBP subphase, signal qualities of neighbor APs in one group are probed in a manner of active probing; and
selectively performing handoff according to the probed signal qualities of the neighbor APs.

2. The method according to claim 1, wherein in the neighbor group list, neighbor APs belonging to the same group work on the same channel.

3. The method according to claim 1, wherein in the neighbor group list, the number of neighbor APs belonging to the same group is not greater than a predetermined maximum group size.

4. The method according to claim 2, wherein in each PBP subphase, a group of neighbor APs are probed by using unicast probe request.

5. The method according to claim 1, wherein building a neighbor group list comprises deriving information of the neighbor APs through overlapped channel scanning.

6. The method according to claim 1, wherein building a neighbor group list comprises receiving information of the neighbor APs from the serving AP.

7. The method according to claim 1, further comprising buffering outbound traffic of the user terminal in each PBP subphase.

8. The method according to claim 1, further comprising instructing the serving AP to buffer inbound traffic to the user terminal in each PBP subphase.

9. The method according to claim 8, wherein the serving AP is instructed to buffer inbound traffic with power save mode.

10. The method according to claim 1, further comprising:
sending and receiving data traffic via the serving AP during intervals between successive PBP subphases; and
measuring the signal quality of the serving AP before performing said multiple PBP subphases and in the intervals between successive PBP subphases.

11. The method according to claim 10, wherein
probing signal qualities of the neighbor APs comprises sampling the neighbor APs multiple times, and calculating a moving average of Received Signal Strength Indicator (RSSI) of each of the neighbor APs; and
measuring signal quality of the serving AP comprises sampling the serving AP multiple times, and calculating a moving average of RSSI of the serving AP.

12. The method according to claim 1, wherein probing signal qualities of the neighbor APs further comprises dynamically adjusting scanning frequency for each neighbor AP according to its signal quality.

13. The method according to claim 1, wherein selectively performing handoff comprises selecting a best neighbor AP according to the probed signal qualities of the neighbor APs, and performing handoff from the serving AP to the best neighbor AP when the signal quality of the best neighbor AP is higher than the signal quality of the serving AP by a predetermined margin.

14. The method according to claim 13, wherein performing handoff comprises breaking the connection with the serving AP, switching the channel and making authentication and re-association with the best neighbor AP, and wherein channel scanning is not performed during the handoff.

15. The method according to claim 1, wherein the PBP subphases are performed when the signal quality of the serving AP drops below a predetermined threshold.

16. The method according to claim 1, wherein the wireless communication network is a wireless local area network based on 802.11 standard.

17. A terminal used in a wireless communication network, comprising:
a serving access point (AP) measurement unit configured to measure signal quality of a current serving AP;
a neighbor group list unit configured to build a neighbor group list in which possible neighbor APs are divided into one or more groups;
a pre-break probing (PBP) unit coupled with said neighbor group list unit, the PBP unit performing intermittently multiple PBP subphases according to the neighbor group list while not breaking connection with the current serving AP, wherein in each PBP subphase, signal qualities of neighbor APs in one group are probed in a manner of active probing; and
a handoff unit coupled with said serving AP measuring unit and said PBP unit, the handoff unit selectively performing handoff according to the probed signal qualities of the neighbor APs.

18. The terminal according to claim 17, wherein in the neighbor group list, neighbor APs belonging to the same group work on the same channel.

19. The terminal according to claim 17, wherein in the neighbor group list, the number of neighbor APs belonging to the same group is not greater than a predetermined maximum group size.

20. The terminal according to claim 18, wherein the PBP unit probes a group of neighbor APs by using unicast probe request in each PBP subphase.

21. The terminal according to claim 17, wherein the neighbor group list unit comprises means for deriving information of the neighbor APs through overlapped channel scanning.

22. The terminal according to claim 17, wherein the neighbor group list unit comprises means for receiving information of the neighbor APs from the serving AP.

23. The terminal according to claim 17, further comprising an outbound traffic buffer unit that buffers outbound traffic of the terminal in each PBP subphase.

24. The terminal according to claim 17, further comprising an inbound traffic buffer requesting unit that instructs the serving AP to buffer inbound traffic to the terminal in each PBP subphase.

25. The terminal according to claim 24, wherein the inbound traffic buffer requesting unit instructs the serving AP to buffer inbound traffic with power save mode.

26. The terminal according to claim 17, wherein
intervals between successive PBP subphases are used to send and receive data traffic via the serving AP; and
the serving AP measurement unit measures the signal quality of the serving AP before the PBP unit performs said multiple PBP subphases and in the intervals between successive PBP subphases.

27. The terminal according to claim 26, wherein
the PBP unit samples the neighbor APs multiple times, and calculates a moving average of Received Signal Strength Indicator (RSSI) of each of the neighbor APs; and
the serving AP measurement unit samples the serving AP multiple times, and calculates a moving average of RSSI of the serving AP.

28. The terminal according to claim 17, wherein the PBP unit comprises scan frequency adjusting means for dynamically adjusting scanning frequency for each neighbor AP according to its signal quality.

29. The terminal according to claim 17, wherein the handoff unit selects a best neighbor AP according to the probed signal qualities of the neighbor APs, and performs handoff from the serving AP to the best neighbor AP when the signal quality of the best neighbor AP is higher than the signal quality of the serving AP by a predetermined margin.

30. The terminal according to claim 29, wherein during the handoff, the handoff unit breaks the connection with the serving AP, switches the channel and makes authentication and re-association with the best neighbor AP, and does not perform channel scanning.

31. The terminal according to claim 17, wherein the PBP unit performs the PBP subphases when the signal quality of the serving AP drops below a predetermined threshold.

32. The terminal according to claim 17, wherein the terminal is a user terminal used in a wireless local area network based on 802.11 standard.

33. A manufactured article having a machine-readable medium with instructions recorded thereon, which, when executed by an user terminal in a wireless communication system, causes the user terminal to:
build a neighbor group list in which possible neighbor APs are divided into one or more groups;
perform intermittently multiple pre-break probing (PBP) subphases according to the neighbor group list while not breaking current connection with a current serving AP, wherein in each PBP subphase, signal qualities of neighbor APs in one group are probed in a manner of active probing; and
selectively perform handoff according to the probed signal qualities of the neighbor APs.
